(19) United States
(12) Patent Application Publication
(10) Pub. No.: US 2026/0186458 A1
(43) Pub. Date: Jul. 2, 2026

(54) CONTROL MODEL GENERATION DEVICE AND CONTROL MODEL GENERATION METHOD

(71) Applicant: Mitsubishi Electric Corporation, Tokyo (JP)

(72) Inventors: Nobuyuki YOSHIKAWA, Tokyo (JP); Ryoichi TAKASE, Tokyo (JP)

(73) Assignee: Mitsubishi Electric Corporation, Tokyo (JP)

(21) Appl. No.: 19/543,302

(22) Filed: Feb. 18, 2026

Related U.S. Application Data
(63) Continuation of application No. PCT/JP2023/034616, filed on Sep. 25, 2023.

(51) Int. Cl. G05B 13/04

(52) U.S. Cl. CPC G05B 13/048

(57) ABSTRACT

A control model generation device includes: an observation value acquisition unit to acquire a plurality of observation values that are outputs of a control target having non-linear characteristics; a state space model estimation unit to estimate a state space model that expresses a linear approximate curve related to the plurality of observation values acquired; and an upper bound model estimation unit to calculate an estimation error, and estimate an upper bound model that expresses an upper bound of the estimation error, the estimation error being an error between each of the observation values acquired and the linear approximate curve expressed by the state space model estimated. Furthermore, the control model generation device includes a control model generation unit to generate a control model that expresses an equation of motion of the control target using the state space model estimated and the upper bound model estimated.

### CROSS REFERENCE TO RELATED APPLICATION

This application is a Continuation of PCT International Application No. PCT/JP2023/034616, filed on Sep. 25, 2023, which is hereby expressly incorporated by reference into the present application.

### TECHNICAL FIELD

The present disclosure relates to a control model generation device and a control model generation method.

### BACKGROUND ART

There is a control model generation device that generates a control model that expresses an equation of motion of a control target having non-linear characteristics.

As for such a control model generation device, for example, Patent Literature 1 discloses a control device that includes a plurality of mutually different control model candidates. Each of the control model candidates is prepared in advance.

The control device calculates an error between an output of each of the control model candidates and an output of the control target, and selects any one control model candidate from the plurality of control model candidates on the basis of a calculation result of the error.

### CITATION LIST

### Patent Literature

Patent Literature 1: JP H05-303408

### SUMMARY OF INVENTION

### Technical Problem

If a person preparing control model candidates does not have sufficient knowledge related to an operation of a control target, it is generally difficult for the person to prepare a control model candidate that expresses the equation of motion of the control target.

The control device disclosed in Patent Literature 1 has had a problem that it is necessary to prepare the plurality of control model candidates in advance. If, for example, none of the plurality of control model candidates expresses the equation of motion of the control target, even if the control device selects any one control model candidate from the plurality of control model candidates, the control device cannot accurately control the control target.

The present disclosure has been made to solve the above problem, and an object of the present disclosure is to provide a control model generation device that enables a person who has sufficient knowledge related to an operation of a control target to generate a control model that expresses an equation of motion of the control target without preparing a plurality of control model candidates in advance.

### Solution to Problem

A control model generation device according to the present disclosure includes: observation value acquisition circuitry to acquire a plurality of observation values that are outputs of a control target having non-linear characteristics; state space model estimation circuitry to estimate a state space model that expresses a linear approximate curve related to the plurality of observation values acquired by the observation value acquisition circuitry; and upper bound model estimation circuitry to calculate an estimation error, and estimate an upper bound model that expresses an upper bound of the estimation error, the estimation error being an error between each of the observation values acquired by the observation value acquisition circuitry and the linear approximate curve expressed by the state space model estimated by the state space model estimation circuitry. Furthermore, the control model generation device includes control model generation circuitry to generate a control model that expresses an equation of motion of the control target using the state space model estimated by the state space model estimation circuitry and the upper bound model estimated by the upper bound model estimation circuitry.

### Advantageous Effects of Invention

According to the present disclosure, a person who has sufficient knowledge related to an operation of a control target can generate a control model that expresses an equation of motion of the control target without preparing a plurality of control model candidates in advance.

### BRIEF DESCRIPTION OF DRAWINGS

FIG. 1 is a configuration diagram illustrating a control model generation device according to Embodiment 1.

FIG. 2 is a hardware configuration diagram illustrating hardware of the control model generation device according to Embodiment 1.

FIG. 3 is a hardware configuration diagram of a computer in a case where the control model generation device is implemented by software, firmware, or the like.

FIG. 4 is an explanatory view illustrating a relationship between a controller in which a control model CM is implemented and a linear system including both of a state space model Jz and an upper bound model Hz.

FIG. 5A is a graph showing an example of a plurality of observation values f(z) that are outputs of a control target OB, the state space model Jz, and the upper bound model Hz, and FIG. 5B is a graph obtained by rotating the graph in FIG. 5A in such a way that the state space model Jz is a horizontal axis.

FIG. 6 is a flowchart illustrating a control model generation method that is a processing procedure performed by the control model generation device.

FIG. 7 is a configuration diagram illustrating a control model generation device according to Embodiment 2.

FIG. 8 is a hardware configuration diagram illustrating hardware of the control model generation device according to Embodiment 2.

FIGS. 9A and 9B are each an explanatory view illustrating a model selection unit 9 that selects any one controller 31-m of M controllers 31-1 to 31-M.

FIG. 10 is an explanatory view illustrating M partial state spaces JK₁ to JK_{M} included in a state space JK in which the plurality of observation values f(z) are present.

### DESCRIPTION OF EMBODIMENTS

Hereinafter, a mode for carrying out the present disclosure will be described with reference to the accompanying drawings to describe the present disclosure in more detail.

### Embodiment 1

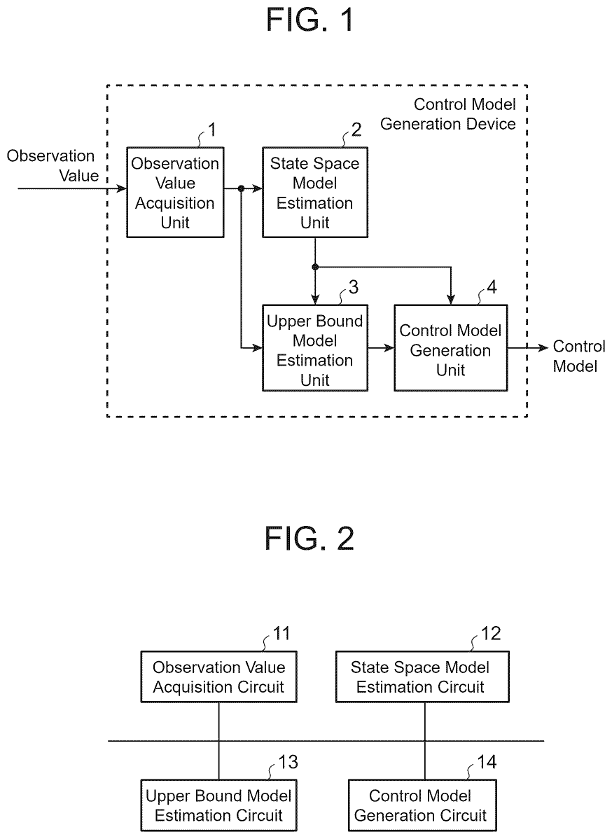

FIG. 1 is a configuration diagram illustrating a control model generation device according to Embodiment 1.

FIG. 2 is a hardware configuration diagram illustrating hardware of the control model generation device according to Embodiment 1.

The control model generation device illustrated in FIG. 1 includes an observation value acquisition unit 1, a state space model estimation unit 2, an upper bound model estimation unit 3, and a control model generation unit 4.

The observation value acquisition unit 1 is implemented by, for example, an observation value acquisition circuit 11 illustrated in FIG. 2.

The observation value acquisition unit 1 acquires a plurality of observation values f(z) that are outputs of a control target OB having non-linear characteristics. The control target OB may be a known control target or may be an unknown control target.

The observation value acquisition unit 1 outputs the plurality of observation values f(z) to each of the state space model estimation unit 2 and the upper bound model estimation unit 3.

The state space model estimation unit 2 is implemented by, for example, a state space model estimation circuit 12 illustrated in FIG. 2.

The state space model estimation unit 2 acquires the plurality of observation values f(z) from the observation value acquisition unit 1.

The state space model estimation unit 2 estimates a state space model Jz that expresses a linear approximate curve related to the plurality of observation values f(z).

The state space model estimation unit 2 outputs the state space model Jz to each of the upper bound model estimation unit 3 and the control model generation unit 4.

The upper bound model estimation unit 3 is implemented by, for example, an upper bound model estimation circuit 13 illustrated in FIG. 2.

The upper bound model estimation unit 3 acquires the plurality of observation values f(z) from the observation value acquisition unit 1, and acquires the state space model Jz from the state space model estimation unit 2.

The upper bound model estimation unit 3 calculates an estimation error |f(z)-Jz| that is an error between each observation value f(z) and the linear approximate curve expressed by the state space model Jz.

The upper bound model estimation unit 3 estimates an upper bound model Hz that expresses an upper bound of the estimation error |f(z)-Jz|.

More specifically, the upper bound model estimation unit 3 estimates the upper bound model Hz using a loss function ζ(t) indicating a difference between a result obtained by multiplying a constant α equal to or less than one on a square value of the upper bound, and a square value of the estimation error |f(z)-Jz|.

The upper bound model estimation unit 3 outputs the upper bound model Hz to the control model generation unit 4.

The control model generation unit 4 is implemented by, for example, a control model generation circuit 14 illustrated in FIG. 2.

The control model generation unit 4 acquires the state space model Jz from the state space model estimation unit 2, and acquires the upper bound model Hz from the upper bound model estimation unit 3.

The control model generation unit 4 generates a control model CM that expresses an equation of motion of the control target OB using the state space model Jz and the upper bound model Hz.

More specifically, the control model generation unit 4 generates, as the control model CM, such a control model that an error between an output of the control model and the linear approximate curve is the upper bound or less.

The control model CM generated by the control model generation unit 4 is implemented in a controller that controls the control target OB.

FIG. 1 assumes that each of the observation value acquisition unit 1, the state space model estimation unit 2, the upper bound model estimation unit 3, and the control model generation unit 4 that are the components of the control model generation device is implemented by dedicated hardware as illustrated in FIG. 2. That is, FIG. 1 assumes that the control model generation device is implemented by the observation value acquisition circuit 11, the state space model estimation circuit 12, the upper bound model estimation circuit 13, and the control model generation circuit 14.

Each of the observation value acquisition circuit 11, the state space model estimation circuit 12, the upper bound model estimation circuit 13, and the control model generation circuit 14 corresponds to, for example, a single circuit, a composite circuit, a programmed processor, a parallel-programmed processor, an Application Specific Integrated Circuit (ASIC), a Field-Programmable Gate Array (FPGA), or a combination thereof.

The components of the control model generation device are not limited to components that are implemented by the dedicated hardware, and the control model generation device may be implemented by software, firmware, or a combination of software and firmware.

The software or the firmware is stored as programs in a memory of a computer.

The computer means hardware that executes the programs, and may correspond to, for example, a Central Processing Unit (CPU), a Graphics Processing Unit (GPU), a center processing device, a processing device, an arithmetic operation device, a microprocessor, a microcomputer, a processor, or a Digital Signal Processor (DSP).

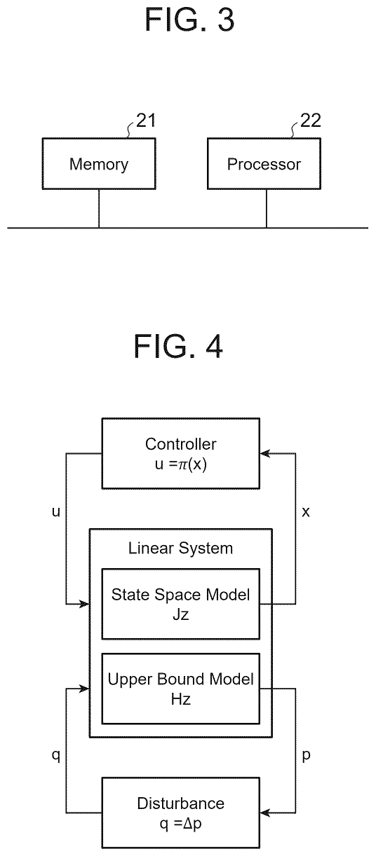

FIG. 3 is a hardware configuration diagram of a computer in a case where the control model generation device is implemented by software, firmware, or the like.

In a case where the control model generation device is implemented by the software, the firmware, or the like, programs for causing the computer to execute processing procedures performed in the observation value acquisition unit 1, the state space model estimation unit 2, the upper bound model estimation unit 3, and the control model generation unit 4 are stored in a memory 21. Furthermore, a processor 22 of the computer executes the programs stored in the memory 21.

Furthermore, FIG. 2 illustrates an example where each of the components of the control model generation device is implemented by dedicated hardware, and FIG. 3 illustrates an example where the control model generation device is implemented by the software, the firmware, or the like. However, these are merely examples, and part of the components of the control model generation device may be implemented by the dedicated hardware, and the rest of the components may be implemented by the software, the firmware, or the like.

FIG. 4 is an explanatory view illustrating a relationship between the controller in which the control model CM is implemented and a linear system that includes both of the state space model Jz and the upper bound model Hz.

FIG. 4 illustrates that an output x of the state space model Jz is given to the controller, and an output u of the controller is given to the linear system.

Furthermore, FIG. 4 illustrates that an output p of the upper bound model Hz is given to disturbance, and q that is the disturbance is given to the linear system.

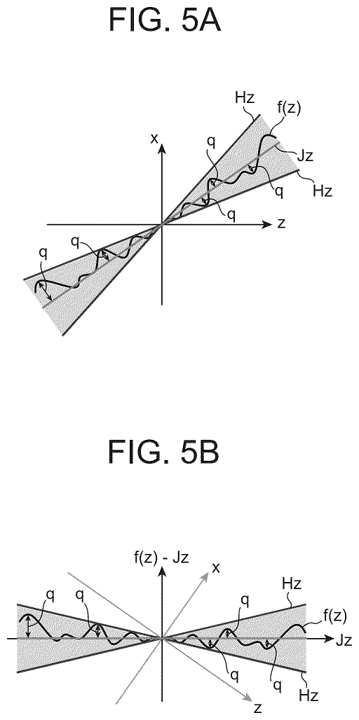

FIG. 5A is a graph showing an example of the plurality of observation values f(z) that are outputs of the control target OB, the state space model Jz, and the upper bound model Hz.

FIG. 5A illustrates an example of a two-dimensional space in which a state space in which the plurality of observation values f(z) that are the outputs of the control target OB are present are expressed by the z axis and the x axis. However, this is merely an example, and the state space may be, for example, a three-dimensional space.

FIG. 5B is a graph obtained by rotating the graph in FIG. 5A in such a way that the state space model Jz is the horizontal axis.

Hence, the equation of motion x dot of the control target OB is expressed as in the following equation (1). In document of the description, a symbol “·” cannot be assigned above a letter x in terms of the electronic application, and therefore is expressed as an x dot.

$$\dot{x} = f ( x , u ) \qquad ( 1 )$$

$$z = {[ {x}^{T} {u}^{T} ]}^{T} \qquad ( 2 )$$

In the equation (2), T represents a mathematical symbol indicating transposition.

A relationship between the plurality of observation values f(z) that are the outputs of the control target OB, the state space model Jz, and the upper bound model Hz is expressed as in the following equation (3).

$${‖ f ( z ) - Jz ‖}_{2} \leq {‖ Hz ‖}_{2} \qquad ( 3 )$$

Hence, the state space model Jz is expressed as in the following equation (4). Furthermore, an estimation error q that is an error between the observation value f(z) and the linear approximate curve expressed by the state space model Jz is expressed as in the following equation (5). The upper bound model Hz is expressed as in the following equation (6).

$$x = Ax + Bu = Jz \qquad ( 4 )$$

$$q = f ( z ) - Jz \qquad ( 5 )$$

$$p = Cx + Du = Hz \qquad ( 6 )$$

In the equation (4) and the equation (6), A, B, C, and D represent any matrices.

A loss function L_{J} of the state space model Jz is expressed as in the following equation (7). Furthermore, a loss function L_{H} of the upper bound model Hz is expressed as in the following equation (8).

$${L}_{j} = 𝔼 [ \frac{1}{2} {q}^{T} q ] \qquad ( 7 )$$

$${L}_{H} = {𝔼}_{x , u \sim β} \{ \begin{matrix}\frac{1}{2} {ξ}^{2} if ξ > 0 , \\ 0 Otherwise\end{matrix} . \qquad ( 8 )$$

$$ξ ( t ) := {‖ q ( t ) ‖}_{2}^{2} - α {‖ p ( t ) ‖}_{2}^{2} \qquad ( 9 )$$

In the equation (9), ζ(t) represents a loss function indicating a difference between a result obtained by multiplying the constant α on a square value of an upper bound p(t), and a square value of an estimation error q(t). α represents a constant equal to or less than one.

Next, an operation of the control model generation device illustrated in FIG. 1 will be described.

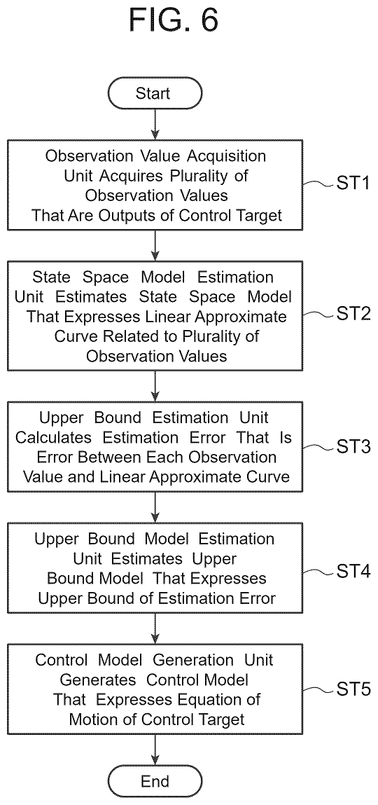

FIG. 6 is a flowchart illustrating a control model generation method that is a processing procedure performed in the control model generation device.

The observation value acquisition unit 1 acquires, from the outside, the plurality of observation values f(z) that are outputs of the control target OB having non-linear characteristics (step ST1 in FIG. 6).

The observation value acquisition unit 1 outputs the plurality of observation values f(z) to each of the state space model estimation unit 2 and the upper bound model estimation unit 3.

The state space model estimation unit 2 acquires the plurality of observation values f(z) from the observation value acquisition unit 1.

As illustrated in FIGS. 5A and 5B, the state space model estimation unit 2 estimates the state space model Jz that expresses the linear approximate curve related to the plurality of observation values f(z) (step ST2 in FIG. 6).

The state space model Jz that expresses the linear approximate curve related to the plurality of observation values f(z) is expressed as in the equation (4).

Although processing of estimating the state space model Jz itself is a known technique, and therefore detailed description thereof will be omitted, it is possible to estimate the state space model Jz by, for example, using a method of searching for a linear approximate curve that minimizes an expected value of an error vector that expresses between the plurality of observation values f(z) and the linear approximate curve.

The state space model estimation unit 2 outputs the state space model Jz to each of the upper bound model estimation unit 3 and the control model generation unit 4.

The upper bound model estimation unit 3 acquires the plurality of observation values f(z) from the observation value acquisition unit 1, and acquires the state space model Jz from the state space model estimation unit 2.

The upper bound model estimation unit 3 calculates the estimation error q that is the error between each observation value f(z) and the linear approximate curve expressed by the state space model Jz as expressed in the equation (5) (step ST3 in FIG. 6).

The upper bound model estimation unit 3 estimates the upper bound model Hz that expresses an upper bound of the estimation error q as expressed in the equation (6) (step ST4 in FIG. 6).

More specifically, the upper bound model estimation unit 3 estimates the upper bound model Hz using the loss function ζ(t) indicating a difference between a result obtained by multiplying the constant α equal to or less than one on a square value of the upper bound p, and a square value of the estimation error q as expressed in the equation (9). The loss function ζ(t) is a function that outputs a vector that upper-bounds a norm of the error vector expressing the difference.

The upper bound model estimation unit 3 outputs the upper bound model Hz to the control model generation unit 4.

The control model generation unit 4 acquires the state space model Jz from the state space model estimation unit 2, and acquires the upper bound model Hz from the upper bound model estimation unit 3.

The control model generation unit 4 generates the control model CM that expresses the equation of motion of the control target OB using the state space model Jz and the upper bound model Hz as expressed in the equation (3) (step ST5 in FIG. 6).

f(z) satisfying the equation (3) corresponds to the control model CM that expresses the equation of motion of the control target OB.

The control model CM generated by the control model generation unit 4 is implemented in the controller that controls the control target OB.

Thus, the controller in which the error between the output of the control model CM and the output of the state space model Jz is regarded as an error input to the control target OB is constructed. An upper bound of the error between the output of the control model CM and the output of the state space model Jz is an upper bound represented by the upper bound model Hz.

In above Embodiment 1, the control model generation device is configured to include: the observation value acquisition unit 1 that acquires a plurality of observation values that are outputs of a control target having non-linear characteristics; the state space model estimation unit 2 that estimates a state space model that expresses a linear approximate curve related to the plurality of observation values acquired by the observation value acquisition unit 1; and the upper bound model estimation unit 3 that calculates an estimation error that is an error between each of the observation values acquired by the observation value acquisition unit 1 and the linear approximate curve expressed by the state space model estimated by the state space model estimation unit 2, and estimates the upper bound model that expresses an upper bound of the estimation error. Furthermore, the control model generation device includes the control model generation unit 4 that generates the control model that expresses the equation of motion of the control target using the state space model estimated by the state space model estimation unit 2 and the upper bound model estimated by the upper bound model estimation unit 3. Accordingly, the control model generation device enables a person who has sufficient knowledge related to an operation of the control target to generate the control model that expresses the equation of motion of the control target without preparing a plurality of control model candidates in advance.

### Embodiment 2

Embodiment 2 will describe a control model generation device that includes a state space division unit 5 that divides a state space in which the plurality of observation values f(z) are present into partial state spaces that are a plurality of spaces.

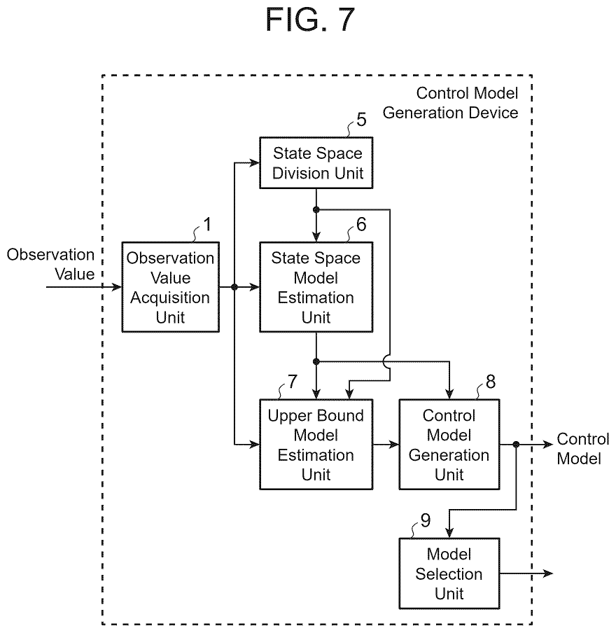

FIG. 7 is a configuration diagram illustrating the control model generation device according to Embodiment 2. Note that, in FIG. 7, the same reference numerals as those in FIG. 1 indicate identical or corresponding parts, and therefore detailed description thereof will be omitted.

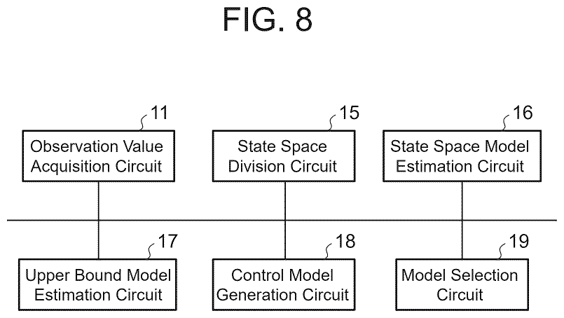

FIG. 8 is a hardware configuration diagram illustrating hardware of the control model generation device according to Embodiment 2. Note that, in FIG. 8, the same reference numerals as those in FIG. 2 indicate identical or corresponding parts, and therefore detailed description thereof will be omitted.

The control model generation device illustrated in FIG. 7 includes the observation value acquisition unit 1, the state space division unit 5, a state space model estimation unit 6, an upper bound model estimation unit 7, a control model generation unit 8, and a model selection unit 9.

The state space division unit 5 is implemented by, for example, a state space division circuit 15 illustrated in FIG. 8.

The state space division unit 5 acquires the plurality of observation values f(z) from the observation value acquisition unit 1.

The state space division unit 5 divides a state space JK in which the plurality of observation values f(z) are present into partial state spaces JK₁ to JK_{M} that are a plurality of spaces. M represents an integer equal to or more than two.

The state space model estimation unit 6 is implemented by, for example, a state space model estimation circuit 16 illustrated in FIG. 8.

The state space model estimation unit 6 acquires the plurality of observation values f(z) from the observation value acquisition unit 1.

The state space model estimation unit 6 estimates a partial state space model Jzₘ that is a state space model expressing a linear approximate curve related to an observation value fₘ(z) present in each of partial state spaces JKₘ (m=1, . . . , and M) divided by the state space division unit 5 among the plurality of observation values f(z).

The state space model estimation unit 6 outputs each of the partial state space models Jzₘ to each of the upper bound model estimation unit 7 and the control model generation unit 8.

The upper bound model estimation unit 7 is implemented by, for example, an upper bound model estimation circuit 17 illustrated in FIG. 8.

The upper bound model estimation unit 7 acquires the plurality of observation values f(z) from the observation value acquisition unit 1, and acquires each of the partial state space models Jzₘ (m=1, . . . , and M) from the state space model estimation unit 6.

The upper bound model estimation unit 7 calculates an estimation error qₘ that is an error between the observation value fₘ(z) present in each of the partial state spaces JKₘ and a linear approximate curve expressed by each of the partial state space models Jzₘ.

The upper bound model estimation unit 7 estimates a partial upper bound model Hzₘ (m=1, . . . , and M) that is an upper bound model that expresses an upper bound of each estimation error qₘ.

The upper bound model estimation unit 7 outputs each partial upper bound model Hzₘ to the control model generation unit 8.

The control model generation unit 8 is implemented by, for example, a control model generation circuit 18 illustrated in FIG. 8.

The control model generation unit 8 acquires the partial state space model Jzₘ (m=1, . . . , and M) from the state space model estimation unit 6, and acquires the partial upper bound model Hzₘ (m=1, . . . , and M) from the upper bound model estimation unit 3.

The control model generation unit 8 generates a control model CMₘ (m=1, . . . , and M) that corresponds to the partial state space JKₘ using the partial state space model Jzₘ and the partial upper bound model Hzₘ.

The control model CMₘ generated by the control model generation unit 8 is implemented in a controller 31-m (m=1, . . . , and M) to be described later.

The model selection unit 9 is implemented by, for example, a model selection circuit 19 illustrated in FIG. 8.

The model selection unit 9 selects any one control model from the control models CMₘ (m=1, . . . , and M) generated by the control model generation unit 8 and corresponding to the M partial state spaces JK₁ to JK_{M}.

More specifically, the model selection unit 9 calculates an error Δeₘ (m=1, . . . , and M) between an output of the control model CMₘ corresponding to each of the M partial state spaces JK₁ to JK_{M}, and a linear approximate curve expressed by the partial state space model Jzₘ.

The model selection unit 9 selects any one control model on the basis of calculation results of M errors Δe₁ to Δe_{M}.

FIG. 7 assumes that each of the observation value acquisition unit 1, the state space division unit 5, the state space model estimation unit 6, the upper bound model estimation unit 7, the control model generation unit 8, and the model selection unit 9 that are the components of the control model generation device is implemented by dedicated hardware as illustrated in FIG. 8. That is, it is assumed that the control model generation device is implemented by the observation value acquisition circuit 11, the state space division circuit 15, the state space model estimation circuit 16, the upper bound model estimation circuit 17, the control model generation circuit 18, and the model selection circuit 19.

Each of the observation value acquisition circuit 11, the state space division circuit 15, the state space model estimation circuit 16, the upper bound model estimation circuit 17, the control model generation circuit 18, and the model selection circuit 19 corresponds to, for example, a single circuit, a composite circuit, a programmed processor, a parallel-programmed processor, an ASIC, an FPGA, or a combination thereof.

The components of the control model generation device are not limited to components that are implemented by the dedicated hardware, and the control model generation device may be implemented by software, firmware, or a combination of software and firmware.

In a case where the control model generation device is implemented by the software, the firmware, or the like, programs for causing the computer to execute processing procedures performed in the observation value acquisition unit 1, the state space division unit 5, the state space model estimation unit 6, the upper bound model estimation unit 7, the control model generation unit 8, and the model selection unit 9 are stored in the memory 21 illustrated in FIG. 3. Furthermore, the processor 22 illustrated in FIG. 3 executes the programs stored in the memory 21.

Furthermore, FIG. 8 illustrates an example where each of the components of the control model generation device is implemented by dedicated hardware, and FIG. 3 illustrates an example where the control model generation device is implemented by the software, the firmware, or the like. However, these are merely examples, and part of the components of the control model generation device may be implemented by the dedicated hardware, and the rest of the components may be implemented by the software, the firmware, or the like.

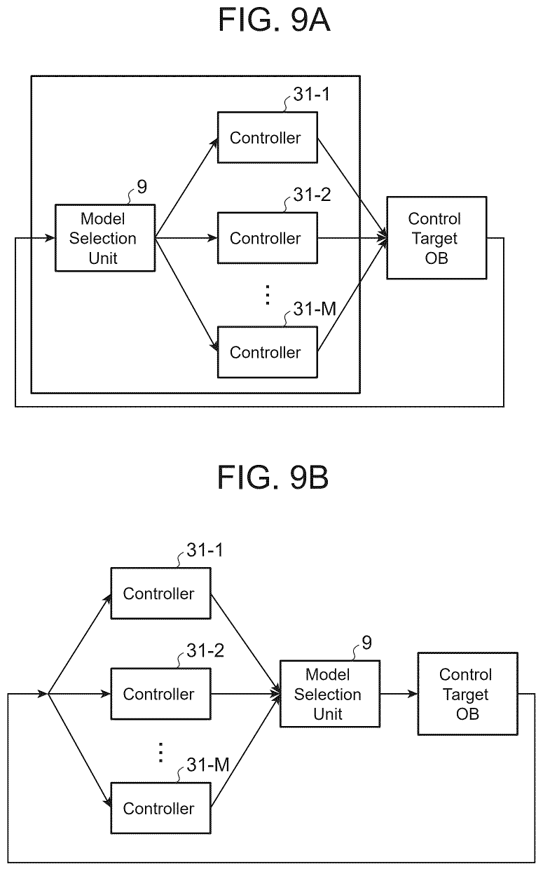

FIGS. 9A and 9B are each an explanatory view illustrating the model selection unit 9 that selects any one controller 31-m of M controllers 31-1 to 31-M.

Each of the controllers 31-1 to 31-M is a controller that controls the control target OB.

The controller 31-m (m=1, . . . , and M) corresponds to the partial state space model Jzₘ.

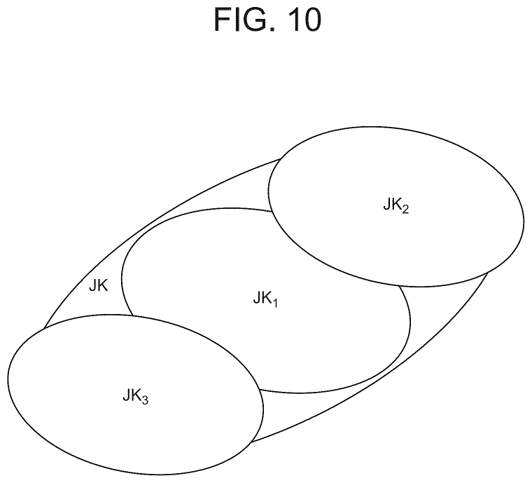

FIG. 10 is an explanatory view illustrating the M partial state spaces JK₁ to JK_{M} included in the state space JK in which the plurality of observation values f(z) are present.

FIG. 10 illustrates an example of M=3.

Next, an operation of the control model generation device illustrated in FIG. 7 will be described.

The observation value acquisition unit 1 acquires, from the outside, the plurality of observation values f(z) that are outputs of the control target OB having non-linear characteristics.

The observation value acquisition unit 1 outputs the plurality of observation values f(z) to each of the state space division unit 5, the state space model estimation unit 6, and the upper bound model estimation unit 7.

The state space division unit 5 acquires the plurality of observation values f(z) from the observation value acquisition unit 1.

As illustrated in FIG. 10, the state space division unit 5 divides the state space JK in which the plurality of observation values f(z) are present into the partial state spaces JK₁ to JK_{M} that are a plurality of spaces.

The state space model estimation unit 6 acquires the plurality of observation values f(z) from the observation value acquisition unit 1.

The state space model estimation unit 6 specifies the observation value fₘ(z) present in each partial state space JKₘ (m=1, . . . , and M) among the plurality of observation values f(z).

The state space model estimation unit 6 estimates the partial state space model Jzₘ that is a state space model expressing a linear approximate curve related to the observation value fₘ(z) present in the partial state space JKₘ.

The partial state space model Jzₘ is expressed as in the following equation (10). Processing of estimating the partial state space model Jzₘ itself is a known technique, and therefore detailed description thereof will be omitted.

The state space model estimation unit 6 outputs the partial state space model Jzₘ (m=1, . . . , and M) to each of the upper bound model estimation unit 7 and the control model generation unit 8.

$$\dot{x} = {A}_{m} x + {B}_{m} u = {Jz}_{m} \qquad ( 10 )$$

In the equation (10), Aₘ and Bₘ represent any matrices.

The upper bound model estimation unit 7 acquires the plurality of observation values f(z) from the observation value acquisition unit 1, and acquires each partial state space model Jzₘ (m=1, . . . , and M) from the state space model estimation unit 6.

The upper bound model estimation unit 7 calculates the estimation error qₘ that is the error between the observation value fₘ(z) present in each partial state space JKₘ and the linear approximate curve expressed by each partial state space model Jzₘ. Processing of calculating the estimation error qₘ is performed in accordance with the following equation (11).

The upper bound model estimation unit 7 estimates the partial upper bound model Hzₘ (m=1, . . . , and M) that is an upper bound model expressing the upper bound of each estimation error qₘ. Processing of estimating the partial upper bound model Hzₘ (m=1, . . . and M) is performed in accordance with the following equation (12).

The upper bound model estimation unit 7 outputs the partial upper bound model Hzₘ (m=1, . . . , and M) to the control model generation unit 8.

$${q}_{m} = {f}_{m} ( z ) - {Jz}_{m} \qquad ( 11 )$$

$${p}_{m} = {C}_{m} x + {D}_{m} u = H {z}_{m} \qquad ( 12 )$$

In the equation (12), Cₘ and Dₘ represent any matrices.

The control model generation unit 8 acquires the partial state space model Jzₘ (m=1, . . . , and M) from the state space model estimation unit 6, and acquires the partial upper bound model Hzₘ (m=1, . . . , and M) from the upper bound model estimation unit 3.

The control model generation unit 8 generates the control model CMₘ that corresponds to the partial state space JKₘ using the partial state space model Jzₘ and the partial upper bound model Hzₘ as expressed in the following equation (13).

fₘ(z) satisfying the equation (13) corresponds to the control model CMₘ that corresponds to the partial state space JKₘ and that expresses the equation of motion of the control target OB.

The control model CMₘ generated by the control model generation unit 8 is implemented in the controller 31-m (m=1, . . . , and M).

$${‖ {f}_{m} ( z ) - {Jz}_{m} ‖}_{2} \leq {‖ {Hz}_{m} ‖}_{2} \qquad ( 13 )$$

The model selection unit 9 selects any one control model CMₘ from the control models CMₘ (m=1, . . . , and M) corresponding to the M partial state spaces JK₁ to JK_{M}.

More specifically, the model selection unit 9 calculates the error Δeₘ (m=1, . . . , and M) between an output uₘ of the control model CMₘ corresponding to each of the M partial state spaces JK₁ to JK_{M}, and the linear approximate curve expressed by the partial state space model Jzₘ as expressed in the following equation (14).

$$Δ {e}_{m} = \vert {u}_{m} - {Jz}_{m} \vert \qquad ( 14 )$$

The model selection unit 9 selects any one control model CMₘ from the M control models CM₁ to CM_{M} on the basis of calculation results of the M errors Δe₁ to Δe_{M}.

More specifically, the model selection unit 9 specifies a minimum error Δe_{MIN} among the errors Δe₁ to Δe_{M}.

The model selection unit 9 selects the control model CMₘ corresponding to the minimum error Δe_{MIN} from the M control models CM₁ to CM_{M}.

The controller 31-m in which the control model CMₘ selected by the model selection unit 9 is implemented among the M controllers 31-1 to 31-M controls the control target OB.

In the control model generation device illustrated in FIG. 7, the model selection unit 9 selects the control model CMₘ corresponding to the minimum error Δe_{MIN} from the M control models CM₁ to CM_{M}. However, this is merely an example, and the model selection unit 9 may select the control model CMₘ corresponding to an error other than minimum error Δe_{MIN} as long as there is no practical problem. More specifically, the model selection unit 9 may select the control model CMₘ whose error is the second smallest, or select the control model CMₘ whose error is the third smallest.

In above Embodiment 2, the control model generation device illustrated in FIG. 7 is configured to include the model selection unit 9 that selects any one control model from control models generated by the control model generation unit 8 and corresponding to the plurality of partial state spaces. Accordingly, similarly to the control model generation device illustrated in FIG. 1, the control model generation device illustrated in FIG. 7 enables a person who has sufficient knowledge related to an operation of the control target to generate the control model that expresses the equation of motion of the control target without preparing a plurality of control model candidates in advance, and can increase control accuracy of the controllers compared to the control model generation device illustrated in FIG. 1.

In the control model generation device illustrated in FIG. 7, the model selection unit 9 calculates the error Δeₘ (m=1, . . . , and M) between the output of the control model CMₘ corresponding to each of the M partial state spaces JK₁ to JK_{M}, and the linear approximate curve expressed by the partial state space model Jzₘ, and selects any one control model on the basis of the calculation results of the M errors Δe₁ to Δe_{M}. However, this is merely an example, and the model selection unit 9 may specify the partial upper bound model Hzₘ whose gradient of an upper bound that is a gain of the partial upper bound model is minimum among the M partial upper bound model HZ₁ to HZ_{M} estimated by the upper bound model estimation unit 7, and selects the control model CMₘ corresponding to the specified partial upper bound model HZₘ from the M control models CM₁ to CM_{M}.

Note that the present disclosure allows free combinations of the embodiments, modification of any components in the embodiments, or omission of any components in the embodiments.

### INDUSTRIAL APPLICABILITY

The present disclosure is suitable for a control model generation device and a control model generation method.

### REFERENCE SIGNS LIST

1: Observation value acquisition unit, 2: State space model estimation unit, 3: Upper bound model estimation unit, 4: Control model generation unit, 5: State space division unit, 6: State space model estimation unit, 7: Upper bound model estimation unit, 8: Control model generation unit, 9: Model selection unit, 11: Observation value acquisition circuit, 12: State space model estimation circuit, 13: Upper bound model estimation circuit, 14: Control model generation circuit, 15: State space division circuit, 16: State space model estimation circuit, 17: Upper bound model estimation circuit, 18: Control model generation circuit, 19: Model selection circuit, 21: Memory, 22: Processor, 31-1 to 31-M: Controller

1. A control model generation device comprising:
observation value acquisition circuitry to acquire a plurality of observation values that are outputs of a control target having non-linear characteristics;
state space model estimation circuitry to estimate a state space model that expresses a linear approximate curve related to the plurality of observation values acquired by the observation value acquisition circuitry;
upper bound model estimation circuitry to calculate an estimation error, and estimate an upper bound model that expresses an upper bound of the estimation error, the estimation error being an error between each of the observation values acquired by the observation value acquisition circuitry and the linear approximate curve expressed by the state space model estimated by the state space model estimation circuitry; and
control model generation circuitry to generate a control model that expresses an equation of motion of the control target using the state space model estimated by the state space model estimation circuitry and the upper bound model estimated by the upper bound model estimation circuitry.

2. The control model generation device according to claim 1, wherein the upper bound model estimation circuitry estimates the upper bound model using a loss function indicating a difference between a result obtained by multiplying a constant equal to or less than one on a square value of the upper bound, and a square value of the estimation error.

3. The control model generation device according to claim 1, wherein the control model generation circuitry generates, as the control model, such a control model that an error between an output of the control model and the linear approximate curve is the upper bound or less.

4. The control model generation device according to claim 1, further comprising a state space division circuitry to divide a state space in which the plurality of observation values acquired by the observation value acquisition circuitry are present into partial state spaces that are a plurality of spaces, wherein
the state space model estimation circuitry estimates a partial state space model that is a state space model expressing a linear approximate curve related to an observation value present in each of the partial state spaces divided by the state space division circuitry among the plurality of observation values acquired by the observation value acquisition circuitry,
the upper bound model estimation circuitry calculates an estimation error, and estimates a partial upper bound model that is an upper bound model expressing an upper bound of the estimation error, the estimation error being an error between the observation value present in each of the partial state spaces and the linear approximate curve expressed by the partial state space model, and
the control model generation circuitry generates a control model that corresponds to each of the partial state spaces and expresses an equation of motion of the control target using the partial state space model estimated by the state space model estimation circuitry and the partial upper bound model estimated by the upper bound model estimation circuitry.

5. The control model generation device according to claim 4, further comprising a model selection circuitry to select any one control model from control models generated by the control model generation circuitry and corresponding to the plurality of partial state spaces.

6. The control model generation device according to claim 5, where the model selection circuitry calculates an error between an output of the control model corresponding to each of the plurality of partial state spaces, and the linear approximate curve, and selects any one control model on a basis of a calculation result of the error between the output of the control model and the linear approximate curve.

7. A control model generation method comprising:
acquiring a plurality of observation values that are outputs of a control target having non-linear characteristics;
estimating a state space model that expresses a linear approximate curve related to the plurality of observation values acquired;
calculating an estimation error, and estimating an upper bound model that expresses an upper bound of the estimation error, the estimation error being an error between each of the observation values acquired and the linear approximate curve expressed by the state space model estimated; and
generating a control model that expresses an equation of motion of the control target using the state space model estimated and the upper bound model estimated.
